(19) United States
(12) Patent Application Publication
(10) Pub. No.: US 2021/0333904 A1
(43) Pub. Date: Oct. 28, 2021

(54) TOUCH KEYBOARD, MANUFACTURING METHOD THEREOF AND MOBILE TERMINAL

(71) Applicants: HEFEI XINSHENG OPTOELECTRONICS TECHNOLOGY CO., LTD., Anhui (CN); BOE TECHNOLOGY GROUP CO., LTD., Beijing (CN)

(72) Inventors: Zhi ZHANG, Beijing (CN); Jiawei XU, Beijing (CN); Qingpu WANG, Beijing (CN); Zhenzhong FANG, Beijing (CN); Taofeng XIE, Beijing (CN)

(21) Appl. No.: 16/318,176

(22) PCT Filed: Jun. 7, 2018
(86) PCT No.: PCT/CN2018/090233

§ 371 Date: Jan. 16, 2019

(30) Foreign Application Priority Data
Aug. 28, 2017 (CN) 201710750850.7

(51) Int. Cl. G06F 3/044

(52) U.S. Cl. CPC G06F 3/044; G06F 2203/04103

(57) ABSTRACT

A touch keyboard including a semi-transparent layer, a touch sensor pattern, and an ink layer. The touch sensor pattern is located at a side of the semi-transparent layer. The ink layer is located at a side of the touch sensor pattern away from the semi-transparent layer.

### CROSS REFERENCE TO RELATED APPLICATIONS

The present application is a 35 U.S.C. 371 national stage application of PCT International Application No. PCT/CN2018/090233, filed on Jun. 7, 2018, which claims the benefit of Chinese patent application No. 201710750850.7, filed on Aug. 28, 2017, the contents of which are incorporated herein by reference in their entireties.

### TECHNICAL FIELD

The present disclosure relates to the technical field of touch input devices, in particular to a touch keyboard, a manufacturing method thereof and a mobile terminal.

### BACKGROUND

Keyboards, as the most commonly used and most important input devices, can input English letters, numbers, punctuation marks, etc. into computers, thus sending commands, inputting data, etc. to computers. The traditional mechanical keyboard uses the principle of a contact switch to make electrical contacts connect or disconnect. Keyboards represent a simple process, have ordinary hand feeling, high noise and are subject to easy wearing of the labels found on the keyboard keys. Moreover, the keys usually use a copper spring as elastic material. These copper springs easily lose their elasticity, thereby increasing the failure rate of keyboards over a long period of time. The principle of the traditional capacitive keyboard is to change the capacitance by changing the distance between the electrodes by pressing the key to temporarily form a capacitive condition that allows an oscillation signal pulse to pass through the capacitance formed by the electrodes, thus realizing a signal corresponding to the selected key. Such a capacitive keyboard is a more complicated technology than mechanical structure.

In recent years, the market has also seen the emergence of a new capacitive touch keyboard, which is similar in principle to a touch screen. The sensor lattice of the common capacitive touch screen needs to be made very dense in order to improve the accuracy of the touch screen. However, for the touch keyboard, a sensor lattice does not need such a high degree of accuracy, but instead only needs to detect a touch in a certain fixed area to identify a touch operation between various areas.

At present, known touch keyboards have the following drawbacks: the pattern of touch sensors is visible to the naked eye, the contrast of key labels is poor, the input error rate is high, there is no corresponding response feedback function at the time of input, the touch input feeling is poor, the process of attaching touch sensor elements to the film of key labels is complicated and the reliability is poor.

Therefore, the structural design of the capacitive touch keyboard at this stage still needs to be improved.

### SUMMARY

The present disclosure is intended to solve at least one of the above technical problems.

An exemplary embodiment provides a touch keyboard.

According to some exemplary embodiments, a touch keyboard comprises: a semi-transparent layer; a touch sensor pattern located at a side of the semi-transparent layer; an ink layer located at a side of the touch sensor pattern away from the semi-transparent layer.

In addition, the touch keyboard according to the above exemplary embodiments may also have the following additional technical features.

According to some exemplary embodiments, an ink layer further comprises a first color layer located at the side of the touch sensor pattern away from the semi-transparent layer, and the first color layer having perforated patterns; and a second color layer located at the side of the first color layer away from the semi-transparent layer; wherein the first color layer is formed of a dark ink and the second color layer is formed of a bright ink.

According to some exemplary embodiments, the first color layer is formed of black ink and the second color layer is formed of white ink or yellow ink.

According to some exemplary embodiments, a touch keyboard further comprises a cover plate located at the side of the semi-transparent layer away from the touch sensor pattern, wherein the cover plate is formed of glass, and the surface of the cover plate away from the semi-transparent layer is frosted.

According to some exemplary embodiments, the semi-transparent layer is formed of semi-transparent ink.

According to some exemplary embodiments, the semi-transparent layer is formed of gray ink.

According to exemplary embodiments, the thickness of the semi-transparent layer is 2-5 microns.

According to some exemplary embodiments, the touch keyboard further includes linear motor(s) for providing vibration feedback when the touch keyboard is input, the linear motor(s) being located in non-key area(s) of the touch keyboard.

According to some exemplary embodiments, the touch keyboard further comprises a light guide plate located at the side of the second color layer away from the semi-transparent layer and arranged at the same layer as the linear motor.

A method for manufacturing a touch keyboard is provided in a second aspect of the exemplary embodiments.

According to some exemplary embodiments, the method comprises forming a semi-transparent layer; forming a touch sensor pattern at a side of the semi-transparent layer; forming an ink layer at the side of the touch sensor pattern away from the semi-transparent layer.

In addition, the manufacturing method according to the above exemplary embodiments may also have the following additional technical features.

According to some exemplary embodiments, the step of forming the ink layer further comprises forming a first color layer at the side of the touch sensor pattern away from the semi-transparent layer; forming a second color layer at the side of the first color layer away from the semi-transparent layer; wherein the first color layer is formed of dark ink, the first color layer has perforated patterns, and the second color layer is formed of bright ink.

According to some exemplary embodiments, before the step of forming the semi-transparent layer, the method further comprises providing a cover plate and frosting the side of the cover plate away from the semi-transparent layer, and the other side of the cover plate being used for forming the semi-transparent layer.

According to some exemplary embodiments, the method further comprises attaching a light guide plate to a display area at the side of the second color layer away from the semi-transparent layer.

According to some exemplary embodiments, the method further comprises arranging linear motor(s) in non-key area(s) at the side of the second color layer away from the semi-transparent layer to provide vibration feedback when the touch keyboard is input.

A mobile terminal may be provided that incorporates exemplary embodiments.

According to some exemplary embodiments, the mobile terminal comprises the touch keyboard described herein.

Additional aspects and advantages of the exemplary embodiments will be set forth in part in the following description, and in part will become apparent from the following description, or may be learned by practice of the present disclosure.

### BRIEF DESCRIPTION OF THE DRAWINGS

The above and/or additional aspects and advantages of the present disclosure will become apparent and readily understood from the description of the embodiments taken in conjunction with the following drawings, in which:

FIG. 1 is a schematic structural view of a longitudinal section of a touch keyboard according to an embodiment of the present disclosure;

FIG. 2 is a schematic structural view of a longitudinal section of a touch keyboard according to another embodiment of the present disclosure;

FIG. 3 is a top view of a first color layer according to an embodiment of the present disclosure;

FIG. 4 is a schematic structural view of a longitudinal section of a touch keyboard according to another embodiment of the present disclosure;

FIG. 5 is a flowchart of a method for manufacturing a touch keyboard according to an embodiment of the present disclosure;

FIG. 6 is a top view photograph of a product corresponding to step S100 of the manufacturing method according to an exemplary embodiment;

FIG. 7 is a top view image of a product corresponding to step S200 of the manufacturing method according to an exemplary embodiment;

FIG. 8 is a top view image of a semi-finished product corresponding to step S300 in the manufacturing method according to an embodiment of the present disclosure;

FIG. 9 is a top view photograph of a product corresponding to step S300 in the manufacturing method according to an embodiment of the present disclosure;

FIG. 10 is a bottom view photograph of a product corresponding to step S300 in the manufacturing method according to an embodiment of the present disclosure;

FIG. 11 is a flowchart of a method for manufacturing a touch keyboard according to another embodiment of the present disclosure; and

FIG. 12 is a bottom view photograph of a product corresponding to step S400 in the manufacturing method according to an exemplary embodiment.

### DETAILED DESCRIPTION

Some exemplary embodiments will be described in detail below, and those of ordinary skill in the art will understand that the following examples are intended to explain the present disclosure and should not be considered as limiting the present disclosure. Unless otherwise specified, if specific techniques or conditions are not explicitly described in the following examples, those of ordinary skill in the art may proceed according to the techniques or conditions commonly used in the art or according to the product specifications.

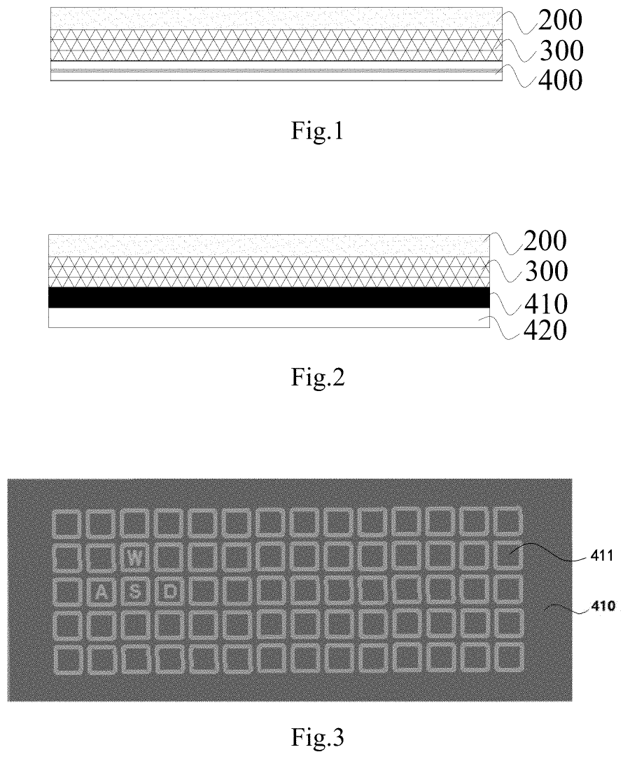

In one exemplary embodiment, a touch keyboard is provided. Referring to FIGS. 1-4, the touch keyboard of the present disclosure will be described in detail.

According to an exemplary embodiment, referring to FIG. 1, the touch keyboard includes a semi-transparent layer 200, a touch sensor pattern 300, and an ink layer 400. The touch sensor pattern 300 is located at a side of the semi-transparent layer 200. The ink layer 400 is located at the side of the touch sensor pattern 300 away from the semi-transparent layer 200.

During research, the inventor found that the touch sensor pattern under the transparent cover plate is visible to naked eyes when viewing known touch keyboards from the user's perspective, thus affecting the overall aesthetics of the touch keyboard. Therefore, in view of the above technical problems, the inventor of the present application can realize the hiding effect of the touch sensor pattern 300 and the hiding effect of the key labels (equivalent to the ink layer 400) when not inputting (backlight is turned off) by providing a semi-transparent layer 200, thereby making the touch keyboard more aesthetically pleasing and meeting the aesthetic requirements of the users.

According to some exemplary embodiment, referring to FIG. 2, the ink layer 400 may include a first color layer 410 and a second color layer 420. The first color layer 410 is located at the side of the touch sensor pattern 300 away from the semi-transparent layer 200. Referring to FIG. 3, the first color layer 410 has perforated patterns 411. The second color layer 420 is located at the side of the first color layer 410 away from the semi-transparent layer 200. The first color layer 410 is formed of dark ink and the second color layer 420 is formed of bright ink. It should be noted that “dark color” refers to black, dark blue, deep purple and other colors that are thicker or darker than orthochromatic color (pure color), while “bright color” refers to white, bright orange, golden yellow and other colors with higher brightness. In this way, by providing the first color layer 410 and the second color layer 420 with obvious color difference, the highlighting of the touch keyboard keys at the time of input (backlight on) can be realized, thereby helping the user to reduce the input error rate.

According to some exemplary embodiments, the specific types of dark ink and bright ink are not particularly limited, and those of ordinary skill in the art can choose according to the actual color difference effect and aesthetics of the ink layer. In some exemplary embodiments, the first color layer 410 may be formed of black ink and the second color layer 420 may be formed of white ink or yellow ink. In this way, using the contrast color with the largest color difference can further improve the color difference of key labels at the time of input and help to further reduce the input error rate. According to some exemplary embodiments, the specific thicknesses of the dark ink and the bright ink are not particularly limited, and those of ordinary skill in the art can adjust them according to the display effect of the touch keyboard at the time of input, which will not be described here.

According to some exemplary embodiments, the specific design of the perforated patterns 411 of the first color layer 410, including the position, shape, etc., is not particularly limited, and those of ordinary skill in the art can design it according to the preferences of the user of the touch keyboard. In some exemplary embodiments, referring to FIG. 3, the perforated patterns 411 may include at least one of rounded square key frames, key letters (e.g., A, S, D, W, etc.), numbers, symbols, shortcut abbreviations, icons, or trademarks. In this way, when the touch keyboard is touched to input, the comprehensive keyboard information is highlighted, which is more helpful to further reduce the input error rate, and the design is more humanized.

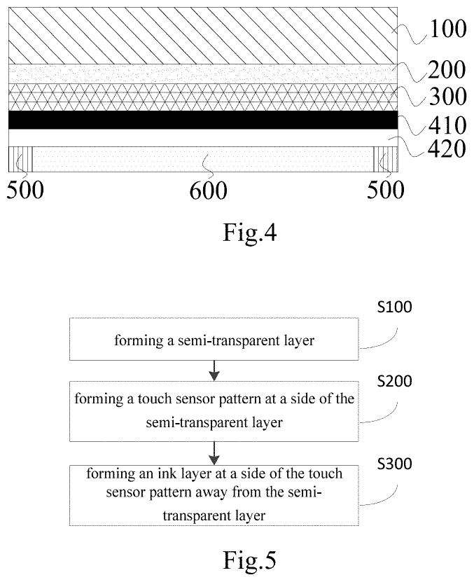

According to some exemplary embodiments, referring to FIG. 4, the touch keyboard may further include a cover plate 100. The cover plate 100 is located at the side of the semi-transparent layer 200 away from the touch sensor pattern 300. In this way, the cover plate 100 is in direct contact with the user's finger, thereby effectively protecting the touch sensor pattern 300 and keeping the appearance of the touch keyboard smooth and stylish. According to some exemplary embodiments, the specific material of the cover plate 100 is not particularly limited, and in particular, it can be e.g., glass, plexiglass, etc. Those of ordinary skill in the art can choose according to the actual use environment of the touch keyboard. In some exemplary embodiments, the cover plate 100 may be formed of glass, and the surface of the cover plate 100 away from the semi-transparent layer 200 is frosted. In this way, the surface roughness of the glass can be improved through the frosting treatment, so that the touch feeling when the hand touches the glass cover plate is better, and the reflection degree of the cover plate is also reduced.

According to some exemplary embodiments, the specific material of the semi-transparent layer 200 is not particularly limited, as long as the semi-transparent layer of the material can effectively block the touch sensor pattern and the ink layer when not inputting, and does not affect the highlighting of the key labels at the time of input, those of ordinary skill in the art can choose according to the actual effect of the touch sensor pattern and the ink layer. In some exemplary embodiments, the semi-transparent layer 200 may be formed of semi-transparent ink, so that the hiding effect of the key iii labels and the touch sensor pattern can be realized when not inputting. Besides, the manufacturing process is simple and the cost is low. In some specific examples, the semi-transparent layer 200 may be formed of gray ink, so that the hiding effect of the key labels and the touch sensor pattern when not inputting can be realized, and the highlighted effect of the key labels will not be affected at the time of input.

According to some exemplary embodiments, the specific thickness of the semi-transparent layer 200 is not particularly limited, as long as the semi-transparent layer of this thickness can achieve the hiding effect of the key labels and the touch sensor pattern when not inputting and does not affect key labels at the time of input, and those of ordinary skill in the art can adjust it according to the actual backlight intensity of the touch keyboard. In some exemplary embodiments, the thickness of the semi-transparent layer 200 may be 2-5 microns, so that not only the hiding effect of the key labels and the touch sensor pattern is better when not inputting, but also the highlighted effect of the key labels is better at the time of input.

According to some exemplary embodiments, the specific shape of the cross-section of the touch keyboard is not particularly limited, and in particular, it can be e.g., rectangular, elliptical or irregular shapes, etc. Those of ordinary skill in the art can design the touch keyboard according to the actual use environment of the touch keyboard and other associated devices. In some exemplary embodiments, the cross section of the touch keyboard can be rectangular, so that wires or other auxiliary functional components can be arranged in the border area and the border area can be made of full use. Moreover, this arrangement is more conducive to the thinning of the touch keyboard.

According to some exemplary embodiments, the touch keyboard may further include linear motors 500, and the linear motors 500 are located in non-key areas of the touch keyboard. It should be noted that “non-key areas” refer specifically to areas other than key frames on the touch keyboard, such as outer frames, gaps between keys, etc. In this way, arranging the linear motors 500 in the non-key areas can realize humanized key vibration feedback during input, thus making the touch keyboard more ergonomic.

According to some exemplary embodiments, the specific position and the specific number of the linear motors 500 are not particularly limited, as long as the linear motors can realize the function of response feedback and does not affect the touch sensing input function of the keys, those of ordinary skill in the art can design and change them according to the actual input experience of the touch keyboard. In some exemplary embodiments, when the cross section of the touch keyboard is rectangular, the linear motors 500 may be disposed at least one of the four corners of the non-display area of the touch keyboard, so that the vibration feedback function does not affect the touch sensing input function of the display area. In some specific examples, they are disposed at one corner of the touch keyboard which not only realize the function of response feedback without affecting the touch sensing input function of the keys, but also make full use of the border area, and is conducive to the thinning of the touch keyboard.

According to some exemplary embodiments, the touch keyboard may further include a light guide plate 600, and referring to FIG. 4, the light guide plate 600 is located at the side of the second color layer 420 away from the semi-transparent layer 200 and is disposed in the same layer as the linear motor 500. In this way, the light guide plate 600 defines the display area of the touch keyboard. and the linear motors 500 are located in the outer border area of the non-display area, thereby realizing the display function and the key vibration feedback function during input. At the same time, the same layer arrangement of the light guide plate 600 and the linear motor 500 is also more conducive to the thinning of the touch keyboard.

To sum up, according to some exemplary embodiments, the present disclosure provides a touch keyboard with a semi-transparent layer, which can realize the hiding effect of the touch sensor pattern and the hiding effect of key labels when not inputting, thereby making the touch keyboard more aesthetically pleasing and stylish, thus meeting the aesthetic requirements of users.

In another aspect of the present disclosure, the present disclosure provides a method for manufacturing a touch keyboard. Referring to FIGS. 5-12, the manufacturing method of the present disclosure will be described in detail. According to some exemplary embodiments, referring to FIG. 5, the manufacturing method includes:

S100: forming a semi-transparent layer.

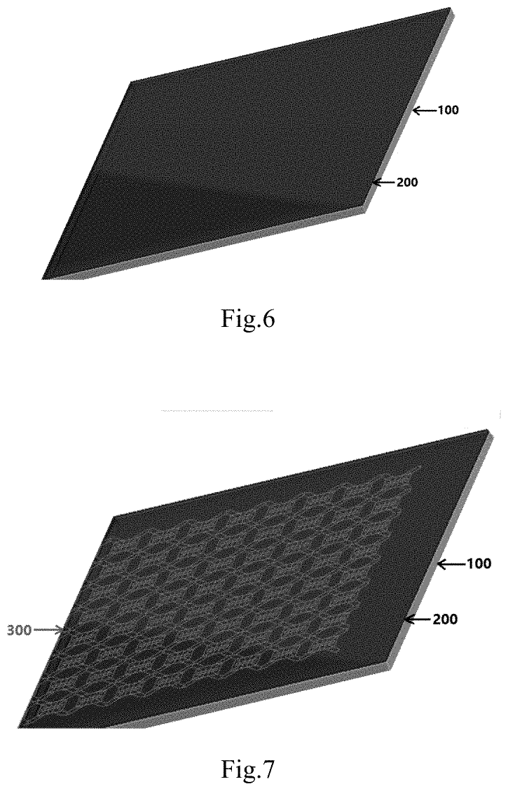

In this step, the semi-transparent layer 200 is first formed. In some exemplary embodiments, referring to FIG. 6, a semi-transparent layer 200 may be formed at a side of the cover plate 100. According to some exemplary embodiments, the specific method of forming the semi-transparent layer 200 is not particularly limited, and those of ordinary skill in the art can choose according to the specific materials of the semi-transparent layer. In some exemplary embodiments, a layer of semi-transparent ink may be coated on a side of the cover plate 100, and the semi-transparent layer 200 may realize the hiding effect of various structures at the side of the touch keyboard away from the cover plate 100 when not inputting, so that it has an integral effect when viewed from the other side of the cover plate 100. In some specific examples, coating a layer of gray ink on the side of the cover plate 100 can more effectively make the touch keyboard have integral effect when not inputting, thus making the touch keyboard more aesthetically pleasing. Moreover, the semi-transparent layer formed by the gray ink will not affect the highlighting of the keys at the time of input.

According to some exemplary embodiments, before step S100, the side of the cover plate 100 away from the semi-transparent layer 200 can be frosted in advance, so that the surface roughness of the side where the cover plate 100 contacts the user's finger can be increased, and the touch feeling can be improved.

S200: forming a touch sensor pattern at a side of the semi-transparent layer.

In this step, the touch sensor pattern 300 is continuously formed at the side of the semi-transparent layer 200 formed in step S100. In some exemplary embodiments, referring to FIG. 7, the touch sensor pattern 300 may be formed at the side of the semi-transparent membrane 200 away from the cover plate 100.

According to some exemplary embodiments, the specific method of forming the touch sensor pattern 300 is not particularly limited, and those of ordinary skill in the art can choose according to the specific material and pattern complexity of the touch sensor pattern 300. In some specific examples, the touch sensor pattern 300 can be screen printed or photoetched directly at the side of the iii semi-transparent membrane 200 away from the cover plate 100, so that a complex touch sensor pattern with touch positioning input function can be designed and manufactured.

S300: forming an ink layer at the side of the touch sensor pattern away from the semi-transparent layer.

In this step, the ink layer 400 is formed at the side of the touch sensor pattern 300 away from the semi-transparent layer 200. Please refer to FIG. 1 for the schematic structural view of the product obtained in this step, where the ink layer 400 is used to display the key graphics at the time of input.

According to some exemplary embodiments, the ink layer 400 may be formed of the first color layer 410 and the second color layer 420, and then step S300 may further include forming the first color layer 410 at the side of the touch sensor pattern 300 away from the semi-transparent layer 200; forming the second color layer 420 at the side of the first color layer 410 away from the semi-transparent layer 200. The first color layer 410 is formed of dark ink, the first color layer 410 has perforated patterns 411, and the second color layer 420 is formed of light ink. In this way, forming the first color layer 410 and the second color layer 420 with obvious color difference can highlight the keys of the touch keyboard and help the user reduce the input error rate.

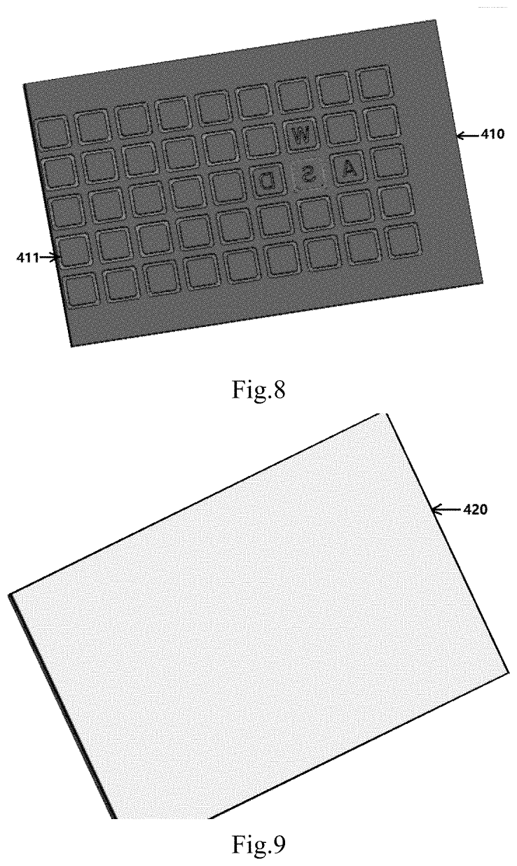

According to some exemplary embodiments, the specific method of forming the first color layer 410 is not particularly limited, and those of ordinary skill in the art can choose according to the specific material of the first color layer 410 and the complexity of the perforated patterns 411. In some exemplary embodiments, referring to FIG. 8, a layer of black ink may be screen printed at the side of the touch sensor pattern 300 away from the cover plate 100. The thus formed first color layer 410 may include complex perforated patterns 411 such as rounded square key frame, key letters, numbers, symbols, shortcut abbreviations, icons or trademarks.

According to some exemplary embodiments, the specific method of forming the second color layer 420 is not particularly limited, and those of ordinary skill in the art can choose according to the specific material of the second color layer 420. In some exemplary embodiments, referring to FIG. 9, a layer of white ink or yellow ink may be screen printed at the side of the first color layer 410 away from the cover plate 100, so that the formed second color layer 420 covers one side of the entire cover plate 100 and covers the perforated patterns 411 of the first color layer 410, thereby realizing the display of key labels at the time of input.

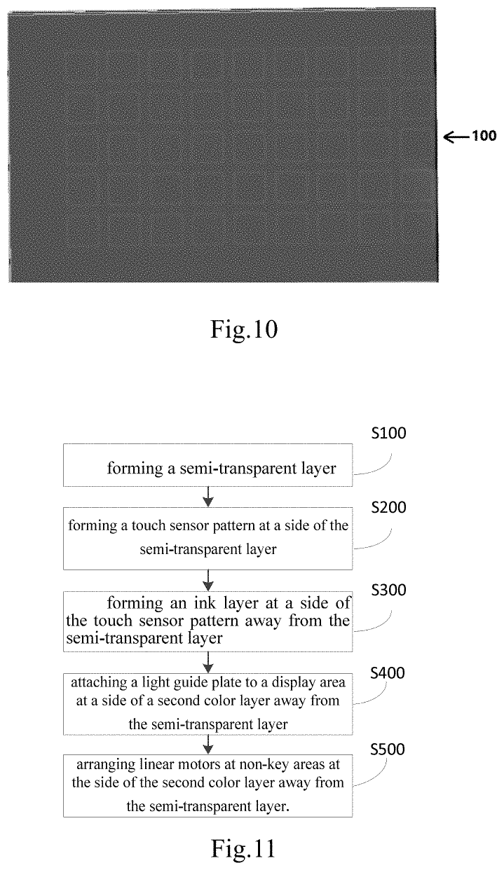

The inventor of the present application has found through a long period of research that, referring to FIG. 10, the superposition and matching of three layers of semi-transparent gray, black and white ink can be used to realize the hiding of the key labels and effectively shield the touch sensor pattern, thereby realizing the integral black effect of the touch keyboard when not inputting, and being aesthetically pleasing and stylish.

According to some exemplary embodiments, referring to FIG. 11, after step s300, the manufacturing method may further include:

S400: attaching a light guide plate to a display area at a side of a second color layer away from the semi-transparent layer.

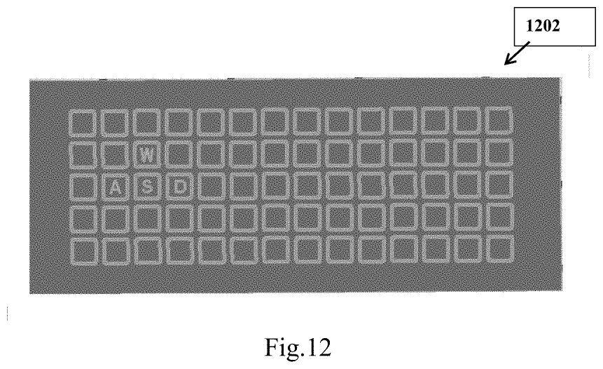

In this step, the light guide plate 600 is attached to the side of the second color layer 420 away from the semi-transparent layer 200. Therefore, when the touch keyboard is input, the light guide plate 600 is turned on to provide backlight for the touch keyboard. Light passes through the second color layer 420 and through the perforated patterns 411 of the first color layer 410, and then passes through the touch sensor pattern 300 and the semi-transparent layer 200 in sequence, thereby displaying the key label pattern 1202 as shown in FIG. 12 and facilitating user key input.

According to some exemplary embodiments, the linear motors 500 are further provided at the side of the light guide plate 600 away from the semi-transparent layer 200 or the side of the second color layer 420 away from the semi-transparent layer 200, so that vibration feedback can be realized through the linear motors 500 when the touch keyboard is input, thereby making the touch keyboard more humanized.

In some exemplary embodiments, the manufacturing method may further include:

S500: arranging linear motors in non-key areas at the side of the second color layer away from the semi-transparent layer.

In this step, the linear motors 500 may be further provided in the non-key areas at the side of the second color layer 420 away from the semi-transparent layer 200, so that vibration feedback can be realized through the linear motors 500 when the touch keyboard is input, thereby making the touch keyboard more humanized.

According to some exemplary embodiments, the specific setting positions of the linear motors 500 are not particularly limited, and can be set in gaps between keys or the outer border area, etc. Those of ordinary skill in the art can design according to the actual structure of the touch keyboard. In a specific example, referring to FIG. 4, the light guide plate 600 defines the display area of the touch keyboard, and the linear motors 500 can be arranged in the same layer as the light guide plate 600 and located in the outer border area outside the display area, so that the touch keyboard can be made thinner and at the same time the key touch positioning input function and the vibration feedback function do not interfere with each other.

To sum up, according to some exemplary embodiments, the present disclosure provides a manufacturing method, a formed semi-transparent layer which can realize a hiding effect of the touch sensor pattern and a hiding effect of the key labels when not inputting, so that a more aesthetically pleasing and stylish touch keyboard can be obtained. Moreover, the process is simple and the manufacturing cost is low.

In another aspect of the present disclosure, the present disclosure provides a mobile terminal.

According to some exemplary embodiments, the mobile terminal includes the touch keyboard described above.

According to some exemplary embodiments, the specific types of mobile terminals are not particularly limited, such as desktop computers, notebook computers, tablet computers, game machines, etc. Those of ordinary skill in the art can design the mobile devices according to the use requirements of the mobile devices and will not be described here.

It should be noted that the mobile terminal includes other necessary components and parts in addition to the touch keyboard. Taking a desktop computer as an example, it includes e.g., a host computer, an output device, a power supply line, etc. Those of ordinary skill in the art can supplement it according to the specific use requirements and use environment of the mobile terminal, and they will not be described here.

To sum up, according to some exemplary embodiments, the present disclosure provides a mobile terminal whose touch keyboard is aesthetically pleasing, has low input error rate and good input feedback, which can increase the market competitiveness of the mobile terminal. Those of ordinary skill in the art can understand that the features and advantages described above for the touch keyboard are still applicable to a mobile terminal and will not be described here.

In the description of the present disclosure, it is to be understood that, the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial” and “circumferential” indicate an orientation or positional relationship based on the orientation or positional relationship shown in the drawings. It is only for the convenience of describing the present disclosure and simplifying the description and is not intended to indicate or imply that the device or element in question must have a particular orientation, or be constructed and operated in a particular orientation, and therefore should not be construed as limiting the present disclosure.

Moreover, the terms “first” and “second” are used for descriptive purposes only and are not to be understood as indicating or implying relative importance or implicitly indicating the number of indicated technical features. Thus, features defining “first” and “second” may explicitly or implicitly include at least one such feature. In the description of this disclosure, “plurality” means at least two, e.g., two, three, etc., unless expressly and specifically defined otherwise.

In the description of this specification, the description with reference to the terms “one exemplary embodiment”, “some exemplary embodiments”, “examples”, “specific examples”, or “some examples” and the like means that a specific feature, structure, material, or characteristic described in connection with the exemplary embodiment or example is included in at least one embodiment or example of the present disclosure. In this specification, the schematic representation of the above terms does not necessarily refer to the same embodiment or example. Moreover, the specific features, structures, materials, or characteristics described may be combined in any one or more embodiments or examples in a suitable manner. In addition, without contradicting each other, those of ordinary skill in the art may integrate and combine different embodiments or examples described in this specification and features of different embodiments or examples.

Although some exemplary embodiments have been shown and described above, it is to be understood that the above embodiments are exemplary and are not to be construed as limitations to the present disclosure, and those of ordinary skill in the art may make changes, modifications, substitutions and variations to the above embodiments within the scope of the present disclosure.

1. A touch keyboard comprising:
a semi-transparent layer;
a touch sensor pattern located at a side of the semi-transparent layer; and
an ink layer located at a side of the touch sensor pattern away from the semi-transparent layer.

2. The touch keyboard according to claim 1, wherein the ink layer comprises:
a first color layer located at the side of the touch sensor pattern away from the semi-transparent layer, and having perforated patterns; and
a second color layer located at a side of the first color layer away from the semi-transparent layer;
wherein the first color layer is formed of dark ink and the second color layer is formed of bright ink.

3. The touch keyboard according to claim 2, wherein the first color layer is formed of black ink and the second color layer is formed from one of white ink or yellow ink.

4. The touch keyboard according to claim 1, further comprising a cover plate which is located at a side of the semi-transparent layer away from the touch sensor pattern, wherein the cover plate is formed of glass, and a surface of the cover plate away from the semi-transparent layer is frosted.

5. The touch keyboard according to claim 2, wherein the semi-transparent layer is formed of semi-transparent ink.

6. The touch keyboard according to claim 5, wherein the semi-transparent layer is formed of gray ink.

7. The touch keyboard according to claim 1, wherein a thickness of the semi-transparent layer is 2-5 microns.

8. The touch keyboard according to claim 1, further comprising a linear motor for providing vibration feedback when the touch keyboard is input, the linear motor being located in non-key area(s) of the touch keyboard.

9. The touch keyboard according to claim 8, further comprising a light guide plate located at a side of the second color layer away from the semi-transparent layer and arranged in a same layer as the linear motor.

10. A method for manufacturing a touch keyboard, comprising following steps:
forming a semi-transparent layer;
forming a touch sensor pattern at a side of the semi-transparent layer;
forming an ink layer at a side of the touch sensor pattern away from the semi-transparent layer.

11. The method according to claim 10, wherein the step of forming the ink layer further comprises:
forming a first color layer at the side of the touch sensor pattern away from the semi-transparent layer;
forming a second color layer at a side of the first color layer away from the semi-transparent layer;
wherein the first color layer is formed of dark ink, and the first color layer has perforated patterns, and the second color layer is formed of bright ink.

12. The method according to claim 11, wherein before the step of forming the semi-transparent layer, the method further comprises:
providing a cover plate and frosting one side of the cover plate away from the semi-transparent layer, the other side of the cover plate being used for forming the semi-transparent layer.

13. The method according to claim 11, further comprising:
attaching a light guide plate to a display area at a side of the second color layer away from the semi-transparent layer.

14. The method according to claim 13, further comprising:
arranging a linear motor at a non-key area located at a side of the second color layer away from the semi-transparent layer to provide vibration feedback when the touch keyboard is input.

15. A mobile terminal comprising the touch keyboard according to claim 1.

16. A mobile terminal comprising the touch keyboard according to claim 2.

17. A mobile terminal comprising the touch keyboard according to claim 3.

18. A mobile terminal comprising the touch keyboard according to claim 4.

19. A mobile terminal comprising the touch keyboard according to claim 7.

20. A mobile terminal comprising the touch keyboard according to claim 8.
